(19) United States
(12) Patent Application Publication
(10) Pub. No.: US 2003/0025420 A1
(43) Pub. Date: Feb. 6, 2003

(54) Electron turbine

(76) Inventor: Jerry D. Noble, Richardson, TX (US)

Correspondence Address: CONLEY, ROSE & TAYON, P.C., 5700 GRANITE PARKWAY,, SUITE 330, PLANO, TX, 75024-6616, US

(21) Appl. No.: 09/924,173

(22) Filed: Aug. 6, 2001

(51) Int. Cl. H02K 17/00

(52) U.S. Cl. 310/232

(57) ABSTRACT

A power generator including a rotating disc shaped permanent magnet. One magnetic pole is at the center of the disc and the other is at its circumference. A slip ring is carried on each face of the disc magnet and a crossover connects the slip rings. Fixed brushes and lead wires contact the two slip rings and make electrical connection through the slip rings and the crossover. The rotating disc causes a constant amplitude and direction magnetic field to continuously pass the lead wires and induce a DC voltage and drive a DC current through the lead wires.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

The present invention relates to rotating equipment for generating electrical power and more particularly to a generator having a rotating disc permanent magnet.

Conventional electrical generators are based on Faraday's law which describes the induction of voltages by a time varying magnetic field. Energy conversion takes place when a change in magnetic flux is associated with mechanical motion. In rotating machines, voltages are generated in windings by rotating the windings through a magnetic field. Due to the motion, the flux linking a specific coil is changed cyclically and a voltage is generated.

Several common types of direct current, DC, generators are based on these principles, but are in reality alternating current, AC, generators. For example, one type of DC generator has a series of coils on a rotor which turns in a magnetic field of a fixed stator winding. The series of coils actually produce an AC voltage, but are connected by a commutator to the power outputs to provide DC power. In a second type, referred to as an alternator, a rotor carries a coil which produces a rotating magnetic field, which alternately applies north and south poles to the stator. Coils in the stator produce an AC voltage as a result of the changing magnetic fields. The coils are connected through a diode bridge to provide a DC output.

Thus, prior DC generators require complicated coils, time varying magnetic fields and some type of AC to DC conversion.

### SUMMARY OF THE INVENTION

A power generator according to the present invention includes a disc-shaped permanent magnet having one magnetic pole at its center and the other around its circumference. Each side of the disc has an electrically conductive slip ring. The disc also has a conductive crossover coupling the slip rings together. Lead wires are positioned in the magnetic field on each side of the disc and are electrically coupled to the rings on each side of the disc. Upon rotation of the disc magnet, a substantially constant magnitude magnetic field moves past both lead wires inducing voltages which drive current through the circuit including the lead wires, the slip rings and crossover.

### BRIEF DESCRIPTION OF THE DRAWINGS

FIG. 1 is a perspective view of a rotating disc magnet generator according to the present invention.

FIG. 2 is a cross-sectional view of the generator shown in FIG. 1.

FIG. 3 is a side view of an embodiment of the present invention having three generator discs coupled in series.

FIG. 4 is a side view of an alternative disc magnet for the FIG. 1 embodiment.

FIG. 5 is a cross-sectional view of an alternative permanent magnet arrangement for concentrating the magnetic field.

### NOTATION AND NOMENCLATURE

In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION OF THE INVENTION

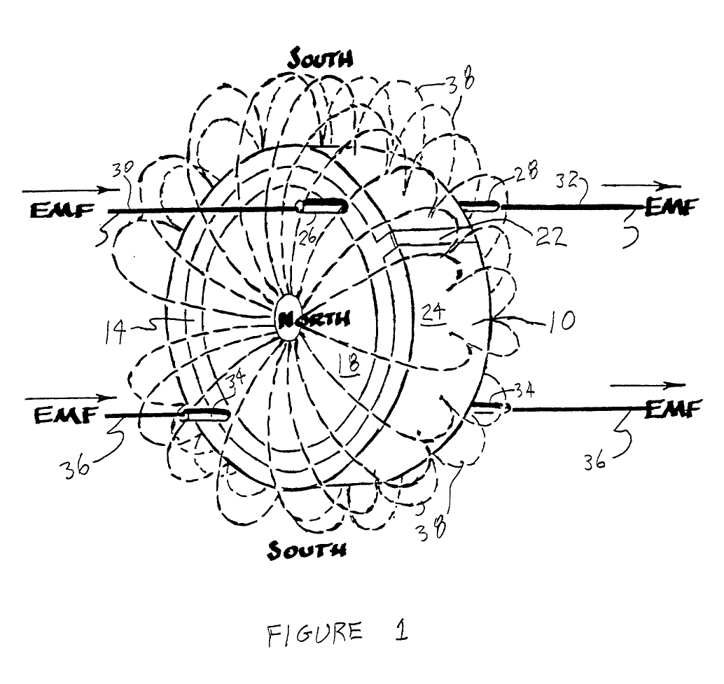

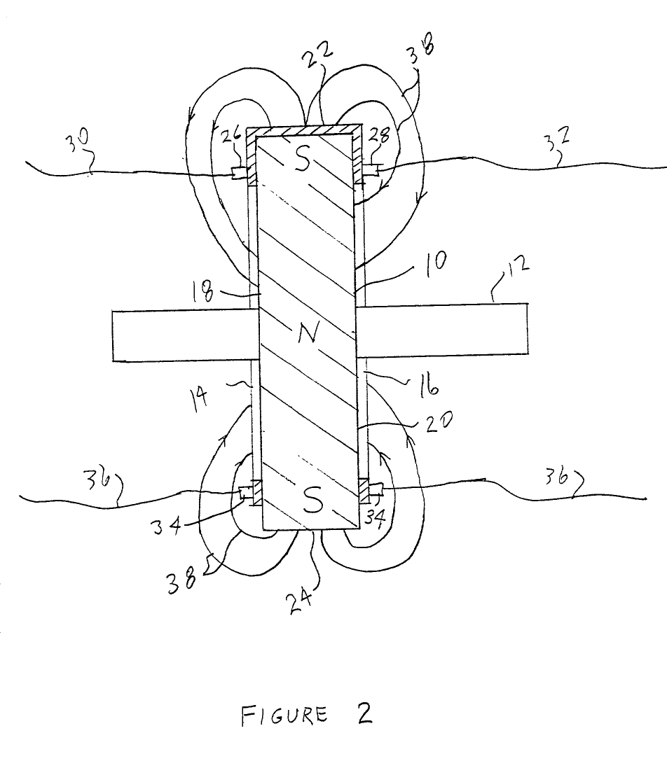

With reference now to FIGS. 1 and 2, a basic electrical generator according to the present invention is shown. The generator includes a disc, or wheel, shaped permanent magnet 10. The disc 10 is mounted on, or attached to, a shaft 12 (shown in FIG. 2). The shaft 12 is supported to allow for rotation about the axis of the shaft. The shaft 12 may be driven by any available source, such as a motor, windmill or any other rotational motive device.

Conductive slip rings 14 and 16 are carried on sides 18 and 20 of the disc magnet 10. At least one conductive crossover 22 is carried on the outer edge, or circumference, 24 of the disc 10. The cross-over 22 electrically couples the slip rings 14 and 16 to each other to allow current to flow from slip ring 14 to slip ring 16. As used herein the term “carried on” means that the slip rings 14, 16 and the crossover 22 are mechanically coupled to the disc magnet 10 so that they move with the disc magnet 10. Crossover 22 may be positioned in a hole through the disc 10 if desired, but this may cause interference with the magnetic characteristics of the disc 10.

In this embodiment, the disc 10 is made of a ceramic magnetic material which is essentially nonconductive electrically. Some magnetic materials are electrically conductive, e.g. iron. If disc 10 is made of such an electrically conductive material, then the slip rings 14 and 16 may simply be selected circular surface areas on the sides 18 and 20 of the disc 10. In that case the disc 10 itself would also provide electrical conductivity between the two slip ring areas 14 and 16 and would therefore form the crossover 22. Thus the disc 10 may form a rotatable permanent magnet, the slip rings 14, 16 and the crossover 22 simultaneously.

A first set of brushes 26 and 28 are positioned on opposite sides of disc 10 to make sliding contact with slip rings 14 and 16 respectively. Lead wires, 30 and 32 are coupled to brushes 26 and 28, respectively. A second set of brushes 34 and lead wires 36 are also shown in contact with the slip rings 14 and 16. A plurality of additional brushes 34 and lead wires 36 may be used, subject to space limitations. The brushes 26, 28, 34 may be any type of sliding contact, including conventional graphite brushes, roller or ball bearing contacts which may provide reduced friction, etc.

The magnetic orientation of the disc 10 is shown by the N, north, and S, south, magnetic pole designations. The magnet is radially magnetized to have a north pole near its center and a south pole around its circumference 24. The opposite polarization may be used if desired. This magnetic orientation produces magnetic flux paths 38 outside of the disc itself. These flux lines 38 run from the circumference 24 of the disc 10 to both sides 18 and 20. The shape and density distribution of the flux lines 38 is generally uniform about the entire circumference of the disc 10. Rotation of disc 10 therefore does not generate alternating or time varying flux fields. The flux lines 38 pass through the brushes 26, 28 and 34 and their respective lead wires 30, 32 and 36.

In operation, the brushes 26, 28, 34 are held in a fixed position while disc 10 is rotated. The lines of flux 38 therefore move past each of the brushes and lead wires. Since the flux 38 is generally constant, there is no time-varying magnetic field as required by prior art generators. In the present invention the magnitude and direction of flux 38 passing through the brushes and lead wires remains generally constant. However, as the disc 10 rotates, the flux field 38 rotates with it. The moving magnetic field produces a force on the electrons in the brushes 26, 28, 34 and their respective lead wires which produces a voltage, e.g. between lead wires 30 and 32. A current can flow between lead wires 30 and 32 because the brushes 26 and 28 are electrically coupled by the slip rings 14 and 16 and the crossover 22. Since the slip rings 14, 16 and the crossover 22 move with the disc 10 and consequently its magnetic field, the electrons within these conductors do not experience a force from the moving magnetic field.

Note that in FIG. 2, the flux lines 38 cross lead wires 30, 32 in generally the same direction. As a result, when the disc 10 rotates, the induced voltages in the two lead wires will be in the same direction, e.g. the voltage on lead wire 30 will be positive when the voltage on lead wire 32 is negative with reference to cross-over 22. The direction of voltage is dependent on the polarity of the magnetization of disc 10 and the direction of rotation.

Since there are no time-varying electric fields, the present invention generates no electromagnetic radiation which can interfere with other equipment and which may represent a loss of energy. Another advantage is that there are no significant induced eddy currents which may also cause energy loss. Likewise, there should be little or no hysteresis losses.

The electromotive force, or voltage, generated by rotation of disc 10 is proportional to the product of the velocity of the magnetic field 38 times the strength of the field 38 times the length of the conductors, e.g. brush 28 and lead wire 32, exposed to the moving magnetic field 38. The voltage can therefore be increased by increasing the speed of rotation of shaft 12. It can also be increased by using a stronger magnet. The flux 38 may also be increased by providing different shaped discs or by adding elements to concentrate the flux, as discussed below. Generator output voltage may be increased by coupling the brushes and lead wires in series on a single disc or by using multiple discs on one shaft.

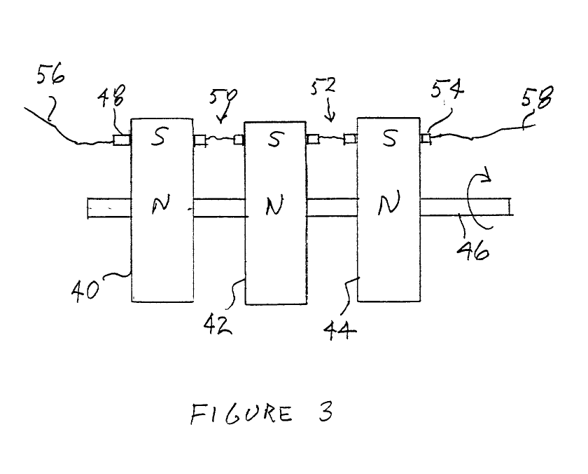

FIG. 3 illustrates the use of three magnetic discs 40, 42, 44 on one shaft 46. The discs 40, 42, 44 may be identical to disc 10 of FIG. 1. Brush 48 is coupled to a slip ring on the left side of disc 40. Two brushes and a lead wire shown at 50 couple the right slip ring on disc 40 to the left slip ring on disc 42. In similar fashion, at 52 two brushes and a lead wire couple the right slip ring on disc 42 to the left slip ring on disc 44. A brush 54 makes a contact to the right slip ring on disc 44. Lead wires 56 and 58 are coupled to brushes 48 and 54 to provide power outputs for the generator. The slip rings are not shown to simplify the figure, but are the same as the rings 14, 16 of FIG. 1. Each disc 40, 42, 44 also includes a crossover like crossover 22 of FIG. 1 to couple its slip rings together electrically.

When the shaft 46 is rotated to rotate the discs 40, 42, 44, a voltage is generated across output leads 56, 58 which is the sum of voltages generated by each of the discs 40, 42, 44. In this case, the output voltage is at least three times the voltage generated by a single disc generator. Any number of discs can be place in series on one shaft to further increase the output voltage. This multiple disc arrangement also helps concentrate the field passing through lead wires, e.g. lead wires 50 and 52 and thereby tends to increase the generated voltage.

The current generated by the devices of FIG. 1 or FIG. 3 can be increased by increasing the number of additional brushes 34 and lead wires 36 as illustrated in FIG. 1. Each set of brushes and lead wires will provide the same current capacity. Since they are electrically coupled through the same slip rings 14, 16 and crossover 22, their output leads must be coupled in parallel.

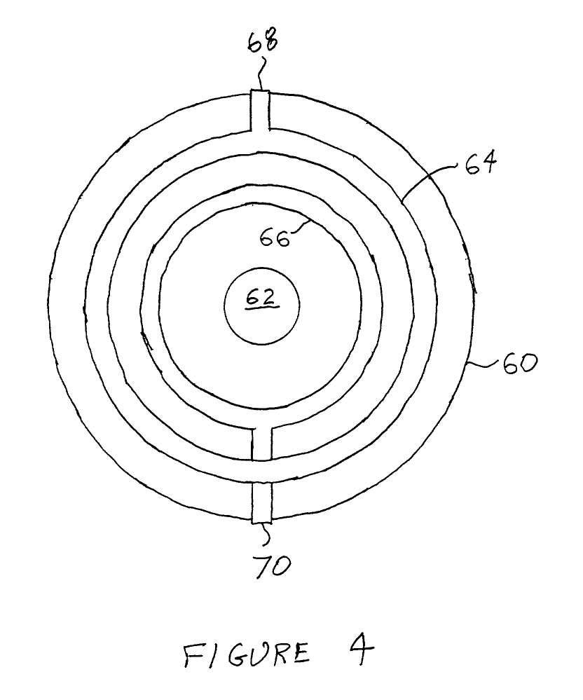

FIG. 4 illustrates an alternative disc arrangement which allows series connection of outputs, and resulting increased voltage, with only one disc. Disc 60 may be essentially identical to disc 10 of FIG. 1. It is carried on a shaft 62. Disc 60 carries two slip rings 64, 66 on each side. Only one side is illustrated. The opposite side may be identical. Slip ring 64 is electrically coupled to its corresponding slip ring on the opposite side by a crossover 68. Slip ring 66 is electrically coupled to its corresponding slip ring on the opposite side by a crossover 70. Crossover 70 passes under and is electrically insulated from slip ring 64.

At least one pair of brushes, e.g. brushes 34 of FIG. 1 are placed into contact with each of the conductive rings 64, 66. When the disc 60 is rotated, the brushes and their respective lead wires provide separate outputs which may be coupled in series to double the output voltage of the generator. By increasing the number of brushes and lead wires on each slip ring 64, 66, the device current capacity may be increased.

It may appear that the voltage generated by brushes on slip ring 66 would be less than for brushes on slip ring 64 because of the different velocity of the flux field at different radii. However, this effect is offset by the fact that the field strength at slip ring 66 is greater than the field strength at slip ring 64. That is, the total field is the same, but it is contained in a smaller space at slip ring 66.

As noted above, the disc magnet 60 may be made of an electrically conductive material. If such a material is used for the FIG. 4 embodiment, then the slip rings 64, 66 and crossovers 68, 70 may be attached to the disc magnet 60 with an electrical insulating layer. Alternatively, one of the slip rings, e.g. slip ring 66, and its crossover, e.g. crossover 70, may be replaced by the disc 60 itself. The other slip ring 64 and its crossover 68 could then be applied to the disc magnet 60 with an electrical insulator so that two independent generator outputs are available and may be connected in series.

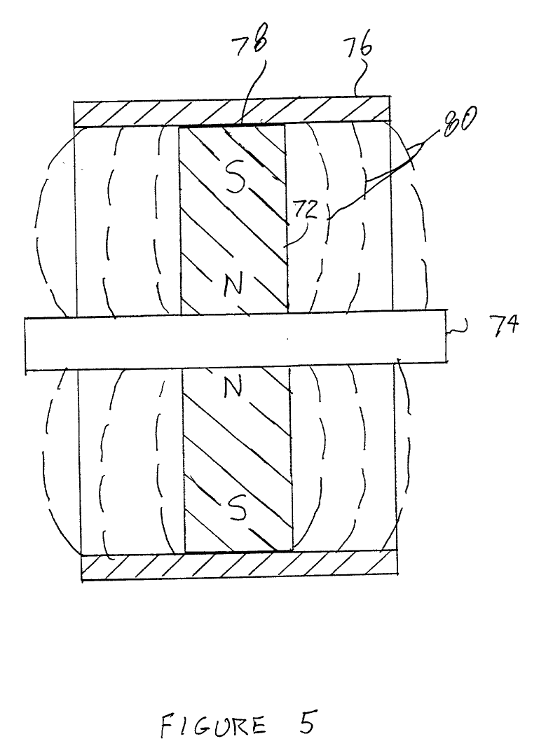

With reference to FIG. 5, an alternative disc magnet arrangement is illustrated. A disc magnet 72 is mechanically different from the disc magnet 10 of FIG. 1, in that it has a central hole to facilitate mounting on a shaft 74. Otherwise, disc magnet 72 may be functionally equivalent to the magnet 10. It has a north polarity near its center and a south polarity at its circumference. A magnetic ring 76 is attached to the outer circumference 78 of the disc 72. The magnetic ring 76 is shaped like a section of a hollow cylinder or pipe. The magnetic ring 76 is preferably made of a high-permeability material. It is also preferred that the shaft 74 be made of a high-permeability material.

The purpose of magnetic ring 76 and the use of high-permeability material for shaft 74 is to concentrate magnetic flux in the area where the brushes and lead wires, e.g. brushes 34 and lead wires 36 of FIG. 1, will be positioned. As illustrated by flux lines 80, the magnetic flux from disc 72 will tend to be concentrated in ring 76 and shaft 74 and pass through the closest air space between them. That is, the air gap is reduced by use of ring 76.

In FIG. 5, the magnetic ring 76 has a length substantially greater than the thickness of disc 72. The magnetic ring 76 may be shorter if desired and may have a length the same as the thickness of disc 72. The effective air gap will still be reduced. In addition, the magnetic ring 76 may serve as an electrical crossover 22 of FIG. 1, especially in a system with a single slip ring 14, 16 on each side as shown in FIGS. 1 and 2. It is also possible for the ring 62 to serve as both slip rings and crossover. That is, brushes 34 of FIG. 1 could be positioned to make sliding contact with the opposite edges of the magnetic ring 76, if it has sufficient electrical conductivity and wear properties. Where multiple crossovers are used, e.g. the FIG. 4 embodiment, the crossovers may pass under or over the magnetic ring 76.

With further reference to FIG. 5, it will be recognized that the magnetic ring 76 can be replaced with an extension of the magnet 72 itself. That is, the magnet need not have a flat disc, or hockey puck, shape. Its outer circumference 78 can be formed with a greater thickness than the rest of the disc. The effect of such a shape would again provide a desirable concentration of flux in the areas on the sides of the disc where it will provide the most effective electromotive force to electrons in the brushes and lead wires.

With further reference to FIGS. 1 and 2, it will be appreciated that the slip rings 14, 16 and crossover 22 may be implemented in several different ways. As illustrated, these elements may be cut from sheet metal, e.g. copper, and bonded to the surfaces of the disc 10. They may also be plated onto the disc 10. When a single slip ring set 14, 16 is used, the entire outer surface of the disc 10 may be covered with a conductive material, e.g. plated with copper. If the disc 10 is made of an electrical conductor, it may provide the functions of the slip rings 14, 16 and the crossover 22.

While the present invention has been illustrated and described in terms of particular apparatus and methods of use, it is apparent that equivalent parts may be substituted of those shown and other changes can be made within the scope of the present invention as defined by the appended claims.

What I claim as my invention is:

1. An electrical power generator comprising:
a generally disc-shaped permanent magnet having one magnetic pole near its center and a second magnetic pole near its circumference.

2. The generator according to claim 1 wherein said magnet has two generally flat sides, further comprising:
a first slip ring on a first side of said magnet,
a second slip ring on a second side of said magnet, and
a first crossover electrically coupling said first slip ring and said second slip ring.

3. The generator according to claim 2 wherein:
said first slip ring, said second slip ring, and said crossover are formed from sheet metal and are carried on said magnet.

4. The generator according to claim 3 wherein:
said crossover is carried on the outer circumference of said magnet.

5. The generator according to claim 2 wherein:
said magnet comprises an electrically conductive material, said first slip ring and said second slip ring are selected areas on the surface of said magnet, and said crossover comprises said magnet.

6. The generator according to claim 2, further comprising:
a first lead wire coupled to said first slip ring, and
a second lead wire coupled to said second slip ring.

7. The generator of claim 6, further comprising:
a first sliding contact coupled to said first lead wire and in sliding contact with said first slip ring, and
a second sliding contact coupled to said second lead wire and in sliding contact with said second slip ring.

8. The generator according to claim 7 wherein:
said sliding contacts comprise graphite brushes.

9. The generator according to claim 2 further comprising:
a first plurality of lead wires coupled to said first slip ring, and
a second plurality of lead wires coupled to said second slip ring.

10. The generator according to claim 9 further comprising:
a first plurality of sliding contacts, each coupled to one of said first plurality of lead wires and each making sliding contact with said first slip ring, and
a second plurality of sliding contacts, each coupled to one of said second plurality of lead wires and each making sliding contact with said second slip ring.

11. The generator according to claim 2 further comprising:
a third slip ring on said first side of said magnet,
a fourth slip ring on said second side of said magnet, and
a second crossover coupling said third slip ring and said fourth slip ring.

12. The generator according to claim 11 further comprising;
a first lead wire coupled to said first slip ring,
a second lead wire coupled to said second slip ring,
a third lead wire coupled to said third slip ring, and
a fourth lead wire coupled to said fourth slip ring.

13. The generator according to claim 12 wherein:
said first and second lead wires form a first generator output, and
said third and fourth lead wires form a second generator output.

14. The generator according to claim 13 wherein:
said first generator output and said second generator output are coupled in series.

15. The generator according to claim 1, further comprising:
a magnetically permeable ring carried on the outer circumference of said disc shaped permanent magnet.

16. The generator according to claim 15, further comprising:
a rotatable shaft supporting said disc shaped permanent magnet for rotation about its center.

17. The generator according to claim 16 wherein:
said shaft comprises a magnetically permeable material.

18. The electrical power generator of claim 1 wherein:
said magnet has a greater thickness at its circumference than at its center.

19. An electrical generator comprising:
a rotatable shaft, and
a plurality of generally disc shaped permanent magnets each having one magnetic pole near its center and a second magnetic pole near its circumference and mechanically carried by said rotatable shaft.

20. The generator according to claim 19, wherein each of said magnets has two generally flat circular sides, further comprising:
a plurality of first slip rings, each on a first side of one of said magnets,
a plurality of second slip rings, each on a second side of one of said magnets, and
a plurality of crossovers electrically coupling said first slip ring and said second slip ring on each of said magnets.

21. The generator of claim 20, further comprising:
a first lead wire coupled to the first slip ring on a first of said magnets,
a second lead wire coupled to the second slip ring on a last of said magnets, and
a plurality of third lead wires coupled between adjacent second and first slip rings carried on intermediate magnets to form a continuous circuit between said first and second lead wires.

22. The generator of claim 21 further comprising:
a plurality of sliding contacts, one each coupled to one of said lead wires and making sliding electrical contact with respective slip rings.
